(19) United States
(12) Patent Application Publication
(10) Pub. No.: US 2021/0402855 A1
(43) Pub. Date: Dec. 30, 2021

(54) CAR WINDOW SCREEN SYSTEM

(71) Applicant: Angela Tam Williams, San Mateo, CA (US)

(72) Inventor: Angela Tam Williams, San Mateo, CA (US)

(21) Appl. No.: 16/914,366

(22) Filed: Jun. 28, 2020

(51) Int. Cl. B60J 1/20; F21S 43/14; F21S 43/15; F21S 9/03

(52) U.S. Cl. CPC B60J 1/2047; B60J 1/205; B60J 1/2069; B60J 1/2077; B60J 1/208; F21W 2106/00; B60J 1/20; F21S 43/14; F21S 43/15; F21S 9/037; B60J 1/2086

(57) ABSTRACT

A car window screen system including a front window screen member, a rear window screen member and a side window screen member. The front window screen member including a first panel and a first plurality of magnets. The first plurality of magnets are attached to a front surface of the first panel for attaching the front window screen member to the car's front window by connecting the first plurality of magnets to a plurality of mating magnets installed along the interior perimeter surface of the car's front window. The rear window including a second panel and a second plurality of magnets. The second plurality of magnets are attached to a front surface of the second panel for attaching the rear window screen member to the car's rear window by connecting the second plurality of magnets to a plurality of mating magnets installed along the interior perimeter surface of the car's rear window. The side window screen member includes a third panel and a third plurality of magnets. The third plurality of magnets are attached to a front surface of the third panel for attaching the side window screen member to the car's side window by connecting the third plurality of magnets to a plurality of mating magnets installed along the interior perimeter surface of the car's side window.

### FIELD OF THE INVENTION

Embodiments described herein generally relate to window screens, and more particularly to car window screen systems.

### BACKGROUND OF THE INVENTION

Traditional ways of keeping the sun out of a car have only been unilateral in function, and sometimes, don't even serve the purpose of keeping the heat out while. Moreover, the traditional ways to block the sun do not prevent onlookers from being able to see inside of the car. With the heat still coming in through the windows on a summer day, the driver will most likely turn the air conditioner on, increasing the cost of gas and wear on the car. Hence, an improved mechanism for blocking the sun out of a car is desirable which can also serve multiple purposes.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1A shows an exemplary front view of a front window screen member attached to a front car window in the car window screen system according to an embodiment of the present disclosure.

FIG. 1B shows an exemplary rear view of a front window screen member attached to a front car window in the car window screen system according to an embodiment of the present disclosure.

FIG. 2A shows an exemplary front view of a rear window screen member attached to a rear car window in the car window screen system according to an embodiment of the present disclosure.

FIG. 2B shows an exemplary rear view of a rear window screen member attached to a rear car window in the car window screen system according to an embodiment of the present disclosure.

FIG. 3A shows another exemplary front view of a front window screen member attached to a front car window in the car window screen system according to an embodiment of the present disclosure.

FIG. 3B shows another exemplary rear view of a front window screen member attached to a front car window in the car window screen system according to an embodiment of the present disclosure.

FIG. 4A shows another exemplary front view of a rear window screen member attached to a rear car window in the car window screen system according to an embodiment of the present disclosure.

FIG. 4B shows another exemplary rear view of a rear window screen member attached to a rear car window in the car window screen system according to an embodiment of the present disclosure.

FIG. 5 shows an exemplary view of a side window screen member of the car window screen system according to an embodiment of the present disclosure.

FIG. 6 shows another exemplary view of a side window screen member of the car window screen system according to another embodiment of the present disclosure.

FIG. 7A shows an exemplary view of magnets positioned along the edge of the interior car window according to an embodiment of the present disclosure.

FIG. 7B shows an exemplary view of the side window screen attached to magnets located on the interior car window according to an embodiment of the present disclosure.

### SUMMARY OF THE INVENTION

Exemplary embodiments disclosed herein describe a car window screen system. The car window screen system including a front window screen member, a rear window screen member and a side window screen member. The front window screen member including a first panel and a first plurality of magnets. The first panel having an aperture configured to fit around the car's rear view mirror and having a frame attached along an outer edge of the first panel. The first plurality of magnets are attached to a front surface of the first panel for attaching the front window screen member to the car's front window by connecting the first plurality of magnets to a plurality of mating magnets installed along the interior perimeter surface of the car's front window. The rear window including a second panel and a second plurality of magnets. The rear window screen member including a second panel having a frame attached along an outer edge of the second panel, wherein the frame includes a light strip for illuminating light. The second plurality of magnets are attached to a front surface of the second panel for attaching the rear window screen member to the car's rear window by connecting the second plurality of magnets to a plurality of mating magnets installed along the interior perimeter surface of the car's rear window. The side window screen member includes a third panel and a third plurality of magnets. The third panel having a same shape and size as the car's side window. The third plurality of magnets are attached to a front surface of the third panel for attaching the side window screen member to the car's side window by connecting the third plurality of magnets to a plurality of mating magnets installed along the interior perimeter surface of the car's side window.

In some exemplary embodiments, the system includes a plurality of side window screen members, each including a respective third panel having a same shape and size as the car's side window.

In some exemplary embodiments, the plurality of side window screen members includes a side window screen for each side window in the car.

In some exemplary embodiments, the first panel has a same shape and size as the car's front window.

In some exemplary embodiments, the fist panel includes an overlapping magnet closure for securing the aperture around the rear view mirror.

In some exemplary embodiments, the second panel The system of claim 1, wherein the second panel has a same shape and size as the car's rear window.

In some exemplary embodiments, the rear window screen member includes a solar panel.

In some exemplary embodiments, the first, second and third panels are made of a material that blocks ultraviolet (UV) rays.

### DETAILED DESCRIPTION

The present disclosure relates to a car window screen system (“the system”). The system may include a window screen for each window in an automobile and the window screens may be used for multiple purposes. Each window screen may be attached to a corresponding window when an individual is ready to use the window screen. An individual may want to attach the window screens to all of the respective corresponding windows to block the sun from all angles of the automobile for maximum cooling effect. Moreover, an individual may want to attach the window screens in all of the windows to shield the contents inside of the automobile from onlookers to reduce break-ins. In some situations, an individual may want to use fewer window screens, such as, for example, when the window screen is used as a hazard alert. Any or all of the window screens may include a LED strip light for increased visibility. Further any or all of the window screens may be imprinted with visual images for marketing and advertisement.

Moreover, the window screens may be attached to a car window using various applications. In one aspect, magnets are affixed to the corners of each of the car windows. The user pops open the window screen, which covers 100% of the window space, and connects mating magnets attached to the window screen to the magnets affixed to the car window. It will take seconds for the magnets to adhere to the window. Further, a couple of inches of fabric may be added to each window screen to ensure all openings are hidden. In another aspect, described below, folding brackets may be used to attach the front and rear window screens to the front and rear windows respectfully. In another aspect, described below, hook clips may be used to attach each side window screen to a side window. In each aspect, the window screen covers the entire corresponding window.

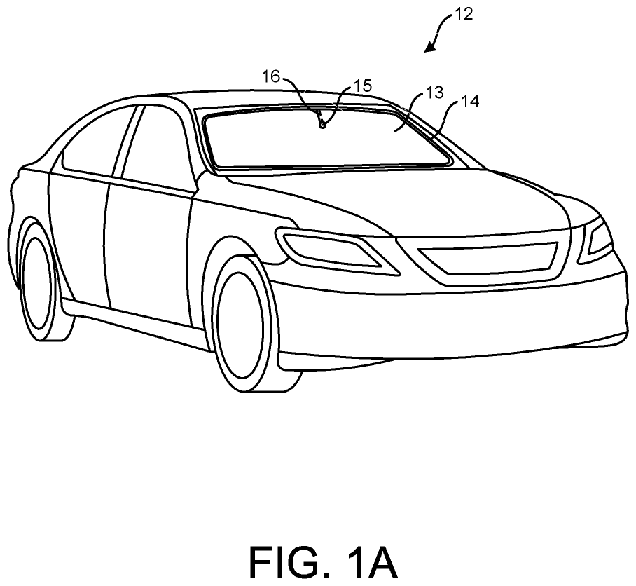

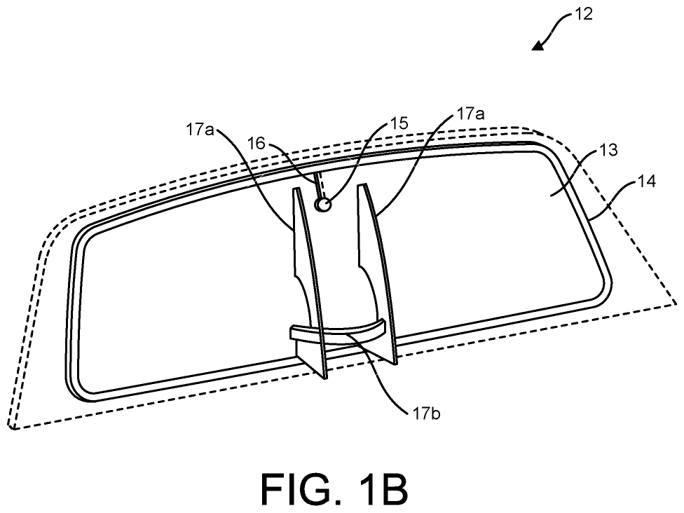

Turning to FIGS. 1-7, the system includes a front window screen member 12, a rear window screen member 18 and one or more side window screen members 24. In a preferred embodiment, the systems includes a plurality of side window screen members, one for each side window in a car (e.g., side window—driver side, side window—front seat passenger, side window—back seat passenger 1, side window—back seat passenger 2). The system includes a variety of attachment mechanisms for attaching each window screen member to an internal surface of a corresponding car window (i.e., front window, rear window, side window—driver side, side window—front seat passenger, side window—back seat passenger 1, side window—back seat passenger 2).

The front window screen member 12 includes a first panel 13, which may be configured to have the same shape and size as the front window of the car. The front window screen member 12 may include a frame 14 attached along an outer edge of the first panel. The first panel may be collapsible and may be made out of a material that blocks ultraviolet (UV) rays, such as, for example, RFID fabric or Nylon. The frame 14 is removable from the first panel. When attached, the frame operates to maintain the first panel in an open (i.e., unfolded) position. Any suitable frame may be used. In a preferred embodiment, the frame is a rubber clip-on frame.

The front window screen member 12 includes an aperture 15 and an overlapping magnet closure 16. The aperture 15 is configured to fit around the car's rear view mirror and the overlapping magnet closure 16 secures the closure of the aperture around the rear view mirror. Moreover, the front window screen member 12 includes an attachment mechanism to attach the front window screen member, with the first panel 13 open, to the inside (i.e., internal surface) of a car's front window.

In one aspect, the attachment mechanism may include first stand member 17. The first stand member attaches the front window screen member 12 to the interior surface of a car's front window by maintaining the front window screen member in an upright position immediately adjacent to the interior surface of the car's front window, as shown in FIG. 1A. The first stand member may be configured to an open position to maintain the front window screen member 12 in the upright position. As illustrated in FIG. 1B, the first stand member 17 may include a pair of folding brackets 17a and a folding bracket holder 17b. The pair of folding brackets 17a include an opening for receiving the folding bracket holder 17b in a horizontal extended position to configure the first stand member in an open position. To detach the front window screen member 12 from the front window, the first stand member may be configured to a closed position by removing the folding bracket holder 17b from the opening of the folding brackets 17a.

In an exemplary embodiment, the first stand member 17 is fixedly attached to the rear surface of the first panel 13. In this embodiment, the folding bracket holder 17b may be positioned upright against the back of the first panel 13 when the first stand member is configured to a closed position (i.e., the folding brackets 17a are in a closed position), and the folding bracket holder may be in a perpendicular position relative to the rear surface of the first panel when the first stand member is open (i.e., the folding brackets 17a are in an open position). When the first stand member 17 is configured to an open position, the folding bracket holder 17b is inserted in the opening of the pair of folding brackets 17a to maintain the pair of folding brackets in an open position.

In another exemplary embodiment, the first stand member 17 is separated from (i.e., not fixedly attached to the first panel) the first panel 13. In this embodiment, the first stand member 17 may be assembled to an open position (i.e., the pair of folding brackets 17a may be unfolded and the folding bracket holder 17b may be inserted in the opening of the pair folding brackets). Thereafter, the first stand member may be placed directly behind the first panel 13 to maintain the first panel in an upright position. In a closed position, the first stand member 17 may be disassembled by removing the folding bracket holder 17b from the opening of the pair of folding brackets.

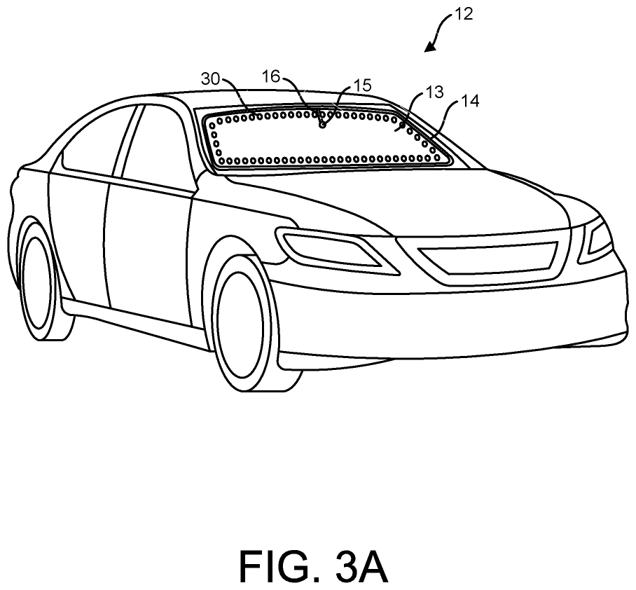

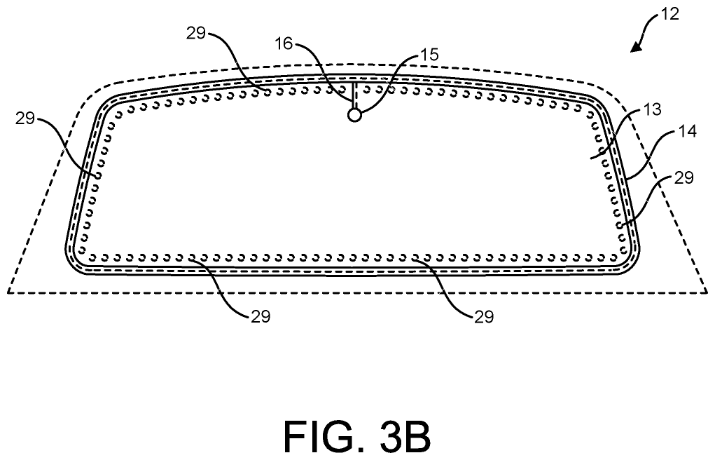

In another aspect, the attachment mechanism may include a plurality of pairs of mating magnets as illustrated in FIG. 3A and FIG. 3B. The plurality of pairs of mating magnets include a first plurality of magnets 29, which are installed along the front surface perimeter of front window screen member 12, and a plurality of mating magnets 30, which are installed along the interior perimeter surface of the car's front window. Each pair of mating magnets 29, 30 are positioned in a same position on the front window screen and the front window respectively so that the pair of magnets may connect to one another. So, the front window screen member 12 is attached to the interior surface of the front window by connecting each magnet 29 to a corresponding mating magnet 30. The front window screen member 12 may be detached from the front window by disconnecting the plurality of pairs of mating magnets.

The rear window screen member 18 includes a second panel 19 having a frame 20 attached along an outer edge of the second panel. The second panel 19 may be configured to have the same shape and size as the rear window of the car. The second panel may be collapsible and may be made out of a material that blocks ultraviolet (UV) rays, such as, for example, RFID fabric or Nylon. The frame 20 is removable from the second panel. When attached, the frame operates to maintain the second panel in an open (i.e., unfolded) position. Any suitable frame may be used. In a preferred embodiment, the frame is a rubber clip-on frame.

The frame 20 may include a light strip 21 installed therein. The light strip 21 may include one or more LEDs for illuminated light therefrom. The light strip may be powered from a solar panel 22 which is integrated on the rear window screen member 18. In another exemplary embodiment, the rear window screen member 18 includes a rechargeable battery for providing power to the light strip 21 after sundown (i.e., when the solar panel is not providing power to the light strip).

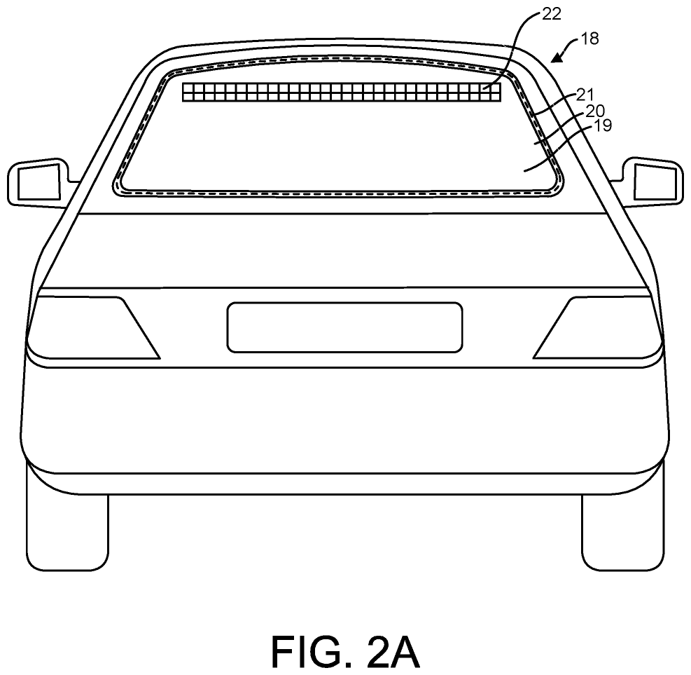

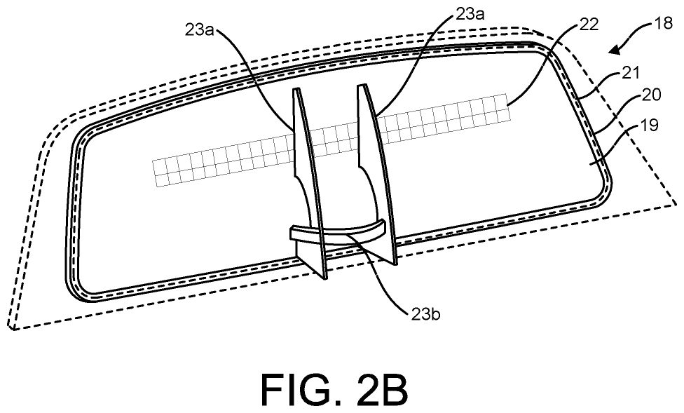

The rear window screen member 18 includes an attachment mechanism to attach the rear window screen member, with the second panel 19 open, to the inside (i.e., internal surface) of a car's rear window. In one aspect, the attachment mechanism includes second stand member 23. The second stand member 23 attaches the rear window screen member 18 to the interior surface of a car's rear window by maintaining the rear window screen member in an upright position immediately adjacent to the interior surface of the car's rear window, as shown in FIG. 2A. The second stand member may be configured to an open position to maintain the rear window screen member 18 in the upright position. As illustrated in FIG. 2B, the second stand member 23 may include a pair of folding brackets 23a and a folding bracket holder 23b. The pair of folding brackets 23a include an opening for receiving the folding bracket holder 23b in a horizontal extended position to configure the second stand member in an open position. To detach the rear window screen member 18 from the rear window, the second stand member 23 may be configured to a closed position by removing the folding bracket holder 23b from the opening of the folding brackets 23a.

In an exemplary embodiment, the second stand member 23 is fixedly attached to the rear surface of the second panel 19. In this embodiment, the folding bracket holder 23b may be positioned upright against the back of the second panel 19 when the second stand member is configured to a closed position (i.e., the folding brackets 23a are in a closed position), and the folding bracket holder 23b may be in a perpendicular position relative to the rear surface of the second panel when the second stand member is open (i.e., the folding brackets 23a are in an open position). When the second stand member 23 is configured to an open position, the folding bracket holder 23b is inserted in the opening of the pair of folding brackets 23a to maintain the pair of folding brackets in an open position.

In another exemplary embodiment, the second stand member 23 is separated from (i.e., not fixedly attached to the second panel) the second panel 19. In this embodiment, the second stand member 23 may be assembled to an open position (i.e., the pair of folding brackets 23a may be unfolded and the folding bracket holder 23b may be inserted in the opening of the pair of folding brackets). Thereafter, the second stand member may be placed directly behind the second panel 19 to maintain the second panel in an upright position. In a closed position, the second stand member 23 may be disassembled by removing the folding bracket holder 23b from the opening of the pair of folding brackets 23a.

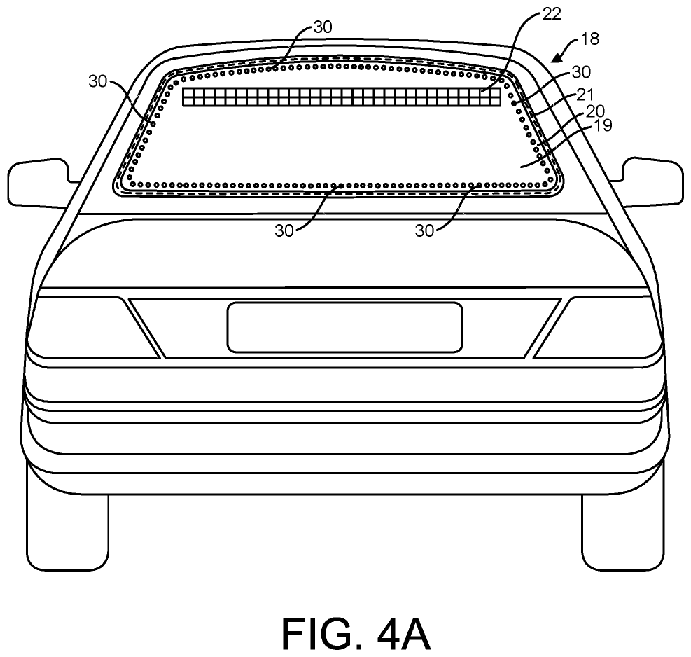

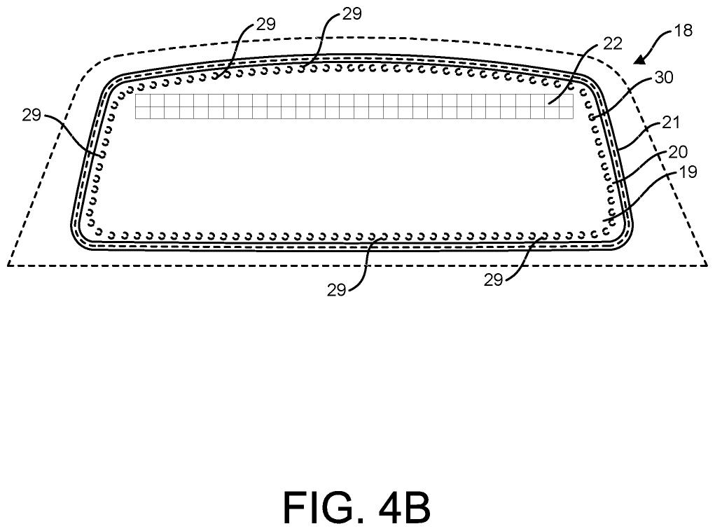

In another aspect, the attachment mechanism may include a plurality of pairs of mating magnets as illustrated in FIG. 4A and FIG. 4B. The plurality of pairs of mating magnets include a second plurality of magnets 29, which are installed along the front surface perimeter of rear window screen member 18, and a plurality of mating magnets 30, which are installed along the interior perimeter surface of the car's rear window. Each pair of mating magnets 29, 30 are positioned in a same position on the rear window screen and the rear window respectively so that the pair of magnets may connect to one another. So, the rear window screen member 18 is attached to the interior surface of the rear window by connecting each magnet 29 to a corresponding mating magnet 30. The rear window screen member 18 may be detached from the rear window by disconnecting the plurality of pairs of mating magnets.

The side window screen member 24 includes a third panel 25 having a same shape and size as a side window of the car. The third panel may be collapsible and may be made out of a material that blocks ultraviolet (UV) rays, such as, for example, RFID fabric or Nylon. The side window screen member 24 is attached to a side window of the car by way of an attachment mechanism.

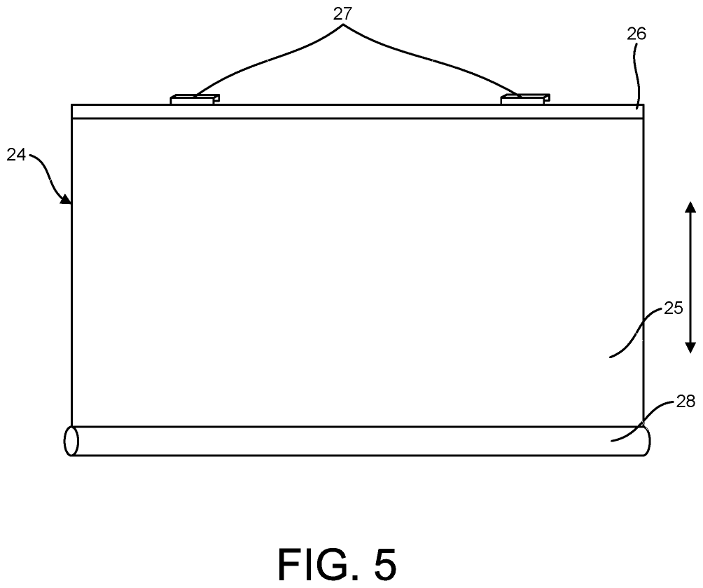

In one aspect, as shown in FIG. 5, the side window screen member 24 may include a roller bar 26 to which the third panel 25 is wrapped around. The roller bar may be attached to the top edge of the third panel. An aluminum tube 28 may be attached to the bottom edge of the third panel. The aluminum tube may be used to extend the wrapped up third panel 25 from around the roller bar. Moreover, the roller bar includes a pair of hook clips 27 (i.e., an attachment mechanism) for attaching the roller bar to the top interior surface of the car's side window, which thereby attaches the side window screen member 24 to the interior surface of the car's side window. Any suitable hook clips may be used, such as, for example, Velcro tabs.

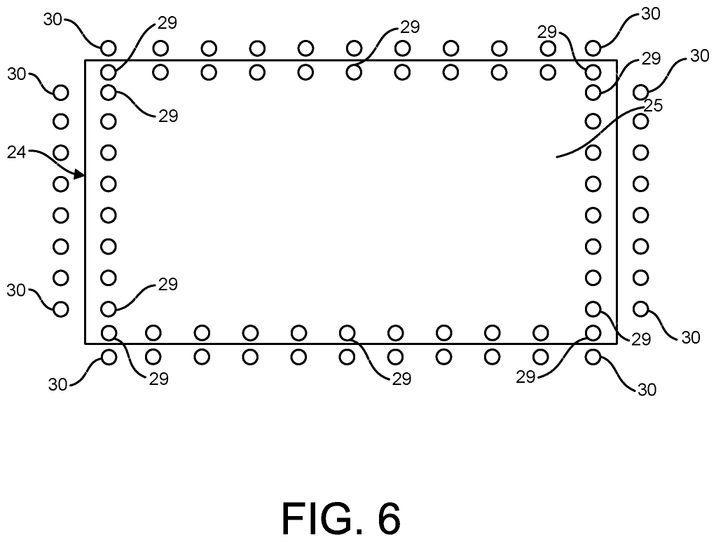

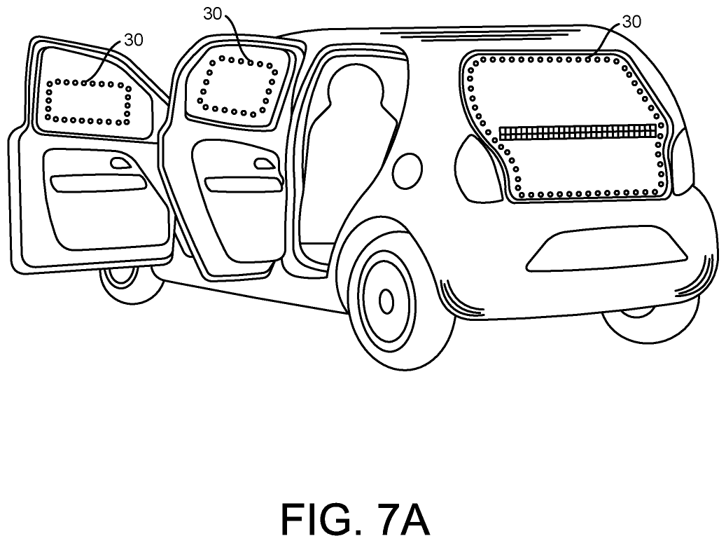

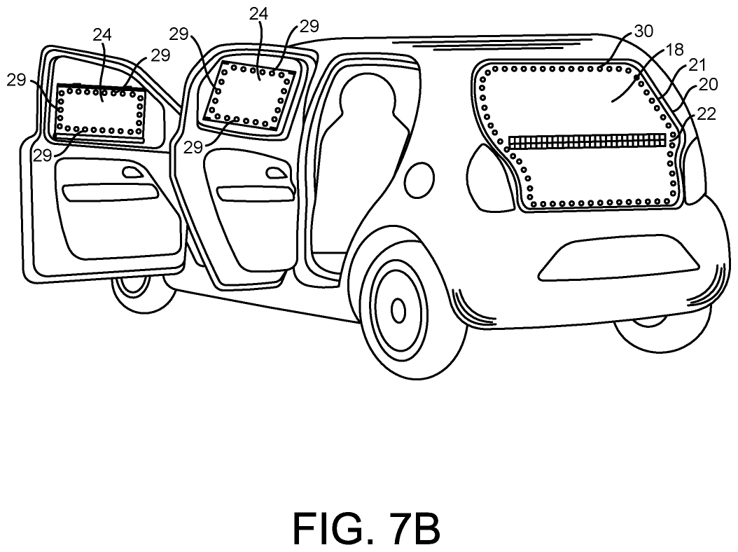

In another aspect, as shown in FIG. 6, the side window screen member 24 does not include a roller bar 26 and an aluminum tube 28, but instead side window screen member 24 includes third panel 25 having a plurality of magnets installed therein. In this aspect, the attachment mechanism includes a plurality of pairs of mating magnets 29, 30. The side window screen member 24 includes a third plurality of magnets 29 positioned along the edge of the window screen 24 for mating/connecting to a plurality of magnets 30 positioned along the edge of an interior car side window, as shown in FIG. 7a and FIG. 7B. Each magnet 29 connects with a corresponding mating magnet attached along the interior perimeter surface of the car's side window. Each pair of mating magnets 29, 30 are positioned in a same position on the window screen member and the side window respectively so that the pair of magnets may connect to one another. So, a side window screen member 24 may be attached to the interior surface of a car's side window by connecting each magnet 29 to a corresponding mating magnet 30. The side window screen member 24 may be detached from the side window by disconnecting the plurality of pairs of mating magnets.

As noted, the system may include a plurality of side window screen members 24, and specifically, the system may include a side window screen member 24 for each side window in the car. Each side window screen member may have a same shape and size as the side window of the car. Each side window of the car has the same dimensions. The plurality of side window screen members may be attached to a corresponding side window by way of an attachment mechanism, which may include hook clips (27) or magnets (29, 30).

While the disclosure describes specific attachment mechanisms for attaching the window screen members to an interior surface of a corresponding car window, other attachment mechanisms may be used to attach the window screen members to an interior surface of a car window. In a preferred embodiment, the window screen members 12, 18 and 24 are attached to the interior surface of a corresponding car window by way of the plurality of pairs of mating magnets.

Moreover, it should be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A car window screen system comprising:
a front window screen member including a first panel, the first panel having an aperture configured to fit around the car's rear view mirror and having a frame attached along an outer edge of the first panel;
a first plurality of magnets attached to a front surface of the first panel for attaching the front window screen member to the car's front window by connecting the first plurality of magnets to a plurality of mating magnets installed along the interior perimeter surface of the car's front window;
a rear window screen member including a second panel having a frame attached along an outer edge of the second panel, wherein the frame includes a light strip for illuminating light;
a second plurality of magnets attached to a front surface of the second panel for attaching the rear window screen member to the car's rear window by connecting the second plurality of magnets to a plurality of mating magnets installed along the interior perimeter surface of the car's rear window;
a side window screen member including a third panel having a same shape and size as the car's side window; and
a third plurality of magnets attached to a front surface of the third panel for attaching the side window screen member to the car's side window by connecting the third plurality of magnets to a plurality of mating magnets installed along the interior perimeter surface of the car's side window.

2. The system of claim 1, further comprising a plurality of side window screen members, each including a respective third panel having a same shape and size as the car's side window.

3. The system of claim 2, wherein the plurality of side window screen members includes a side window screen for each side window in the car.

4. The system of claim 1, wherein the first panel has a same shape and size as the car's front window.

5. The system of claim 1, wherein the first panel includes an overlapping magnet closure for securing the aperture around the rear view mirror.

6. The system of claim 1, wherein the second panel has a same shape and size as the car's rear window.

7. The system of claim 1, wherein the rear window screen member includes a solar panel.

8. The system of claim 1, wherein the first, second and third panels are made of a material that blocks ultraviolet (UV) rays.

9. A car window screen system comprising:
a front window screen member including a first panel, the first panel having an aperture configured to fit around the car's rear view mirror and having a frame attached along an outer edge of the first panel;
a first stand member including a pair of folding brackets and a folding bracket holder for maintaining the front window screen member in an upright position behind the car's front window;
a rear window screen member including a second panel having a frame attached along an outer edge of the second panel, wherein the frame includes a light strip for illuminating light;
a second stand member including a pair of folding brackets and a folding bracket holder for maintaining the rear window screen member in an upright position behind the car's rear window;
a side window screen member including a third panel having a same shape and size as the car's side window; and
a pair of hook clips for attaching the side window screen member to a side window of the car forming a semi-permanent connection.

10. The system of claim 9, wherein the third panel includes a roller bar to which the third panel is wrapped around, the roller bar is attached to the top edge of the third panel.

11. The system of claim 10, wherein the roller bar includes the pair of hook clips for attaching the roller bar to the top of the side window.

12. The system of claim 10, wherein the third panel includes an aluminum tube attached to the bottom edge of the third panel, the aluminum tube is used to extend the wrapped up third panel from around the roller bar.

13. The system of claim 8, further comprising a plurality of side window screen members, each including a respective third panel having a same shape and size as the car's side window.

14. The system of claim 12, wherein the plurality of side window screen members includes a side window screen for each side window in the car.

15. The system of claim 8, wherein the first panel has a same shape and size as the car's front window.

16. The system of claim 8, wherein the first panel includes an overlapping magnet closure for securing the aperture around the rear view mirror.

17. The system of claim 8, wherein the rear window screen member includes a solar panel.

18. The system of claim 8, wherein the first, second and third panels are made of a material that blocks ultraviolet (UV) rays.
